(19) United States
(12) Patent Application Publication
(10) Pub. No.: US 2009/0313550 A1
(43) Pub. Date: Dec. 17, 2009

(54) Theme Based Content Interaction

(75) Inventors: Hisun Kim, Seattle, WA (US); Asta J. Roseway, Bellevue, WA (US); Michael C. Kunz, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,061

(22) Filed: Jun. 17, 2008

(51) Int. Cl. G06F 3/00; G06F 15/16

(52) U.S. Cl. 715/744

(57) ABSTRACT

Techniques are described to provide theme based content interactions. In an implementation, a user interface is provided to enable interactions with a variety of services from a service provider. The user interface may have one or more content portions that are arranged in accordance with a theme associated with a user and/or a corresponding account or client. One or more theme preferences are stored that describe a theme that may be specified by the user through interactions with a service provider. Accordingly, when the user interacts with services provided by the service provider, the service provider may detect a theme associated with the user and output a user interface that includes content portions corresponding to the associated theme.

### BACKGROUND

A vast amount of content is available to users over a network, and the amount is ever increasing. For example, users currently have access to billions of web pages via the Internet. Further, users are exposed to ever increasing types of content, from web pages to images to downloadable music, and so on. Therefore, it may be difficult for service providers and users to locate particular content of interest to the users from this vast amount of available content.

Further, user experience in interacting with content available from a service provider may be enhanced by providing customized interactions. One traditional technique that may be utilized to provide a user with customized interactions is through themes. Traditional themes allow users to customize visual aspects of a web page and/or other user interfaces, such as by selecting custom colors, fonts and fonts size, backgrounds, and so on for a user's home page with a service provider. However, traditional themes may be limited to offline user interfaces (e.g., computer desktop) or personal pages of a user (e.g., a user's home page). Further, traditional themes may have to be individually selected for each page or user interface and are limited to changes in visual aspects.

### SUMMARY

Techniques are described to provide theme based content interactions. In an implementation, a user interface is provided to enable interactions with a variety of services from a service provider. The user interface may have one or more content portions that are arranged in accordance with a theme associated with a user and/or a corresponding account or client. One or more theme preferences are stored that describe a theme that may be specified by the user through interactions with a service provider. Accordingly, when the user interacts with services provided by the service provider, the service provider may detect a theme associated with the user, apply the detected theme, and output a user interface that includes content aspects customized to correspond to the detected theme.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to provide theme based content interaction techniques.

FIG. 2 is an illustration of a system in an example implementation showing a service provider and client of FIG. 1 in greater detail.

FIG. 3 is a flow diagram depicting a procedure in an example implementation in which content output by a service provider is customized in accordance with detected theme preferences.

FIG. 4 is a flow diagram depicting a procedure in an example implementation in which a user defined theme is applied to present content matching the defined theme in a user interface.

FIG. 5 is a flow diagram depicting a procedure in an example implementation in which content in a user interface is updated to reflect selection of a theme.

FIG. 6 is an illustration of an example user interface having content corresponding to a selected theme.

FIG. 7 is an illustration of another example user interface having content corresponding to a selected theme.

FIG. 8 illustrates a procedure in an example implementation in which a client receives content in accordance with a selected theme while interacting with a plurality of services.

### DETAILED DESCRIPTION

Overview

A user may select a theme to customize aspects of a user interface used for interactions with a service provider, computer, operating system, and so forth. However, traditional themes may be limited to personal pages of a user (such as the user's home page, or an operating system desktop) and are limited to changes in visual aspects. Further, a user may have to individually select a theme for each different page and/or user interface. Accordingly, traditional themes do not provide a consistent user experience across interaction that may occur with different service providers, services, features, and corresponding user interfaces. Further, traditional themes do not assist service providers and users in identification of content that may be of interest to the users.

Techniques are described to provide theme based content interaction. A theme as used herein may be a collection of settings for a user interface that are selected to correspond to a particular topic. A variety of different themes are contemplated, such as themes related to hobbies, family, social groups, work, entertainment, services, people, products, music, and so forth. For example, a theme may be centered around “Sports” or a favorite professional sports team. Another theme may be centered around a user's favorite celebrity. Yet another theme may be centered around a hobby of a user, such as a “Garden” theme. A variety of other examples of themes are also contemplated.

Themes have traditionally been applied to change the look and feel (e.g., visual aspects) of a user interface to match the theme. In accordance with theme based content interaction techniques described herein, themes may be extended to apply to content and functionality of a user interface in addition to changing the look and feel.

In an implementation, a user interface is provided to enable interaction with a variety of services from a service provider. One or more theme preferences are stored that describe a theme that may be specified by a user through interaction with a service provider. Accordingly, when the user interacts with services provided by the service provider, the service provider may detect a theme associated with the user and output a user interface to include content portions customized to correspond to the detected theme. The theme may be applied consistently across a variety of services and user interfaces that are provided through the service provider. Variable content portions of the user interfaces may be changed to include content that matches a detected theme. Further content portions related to a theme may be added and removed from a user interface based upon a detected theme to provide theme specific functionality. In this way, themes may be defined to customize both visual aspects and content aspects of user interfaces through which a user may interact with a service provider.

While aspects of theme based content interaction techniques are described herein in relation to services and user interfaces provided by a service provider, it is contemplated that the techniques may be employed to extend themes to content aspects of user interfaces output in a variety of settings. For example, a theme may be applied to customize content aspects of user interfaces output locally at a computer, such as applying the theme to customize content portions of an operating system user interface of a computer, a desktop gadget output on a computer desktop, a user interface of a desktop application, and so forth. A variety of other examples are also contemplated.

In the following discussion, an example environment is first described that is operable to employ theme based content interaction techniques. Example procedures are then described which may be employed by the example environment, as well as in other environments.

Example Environment

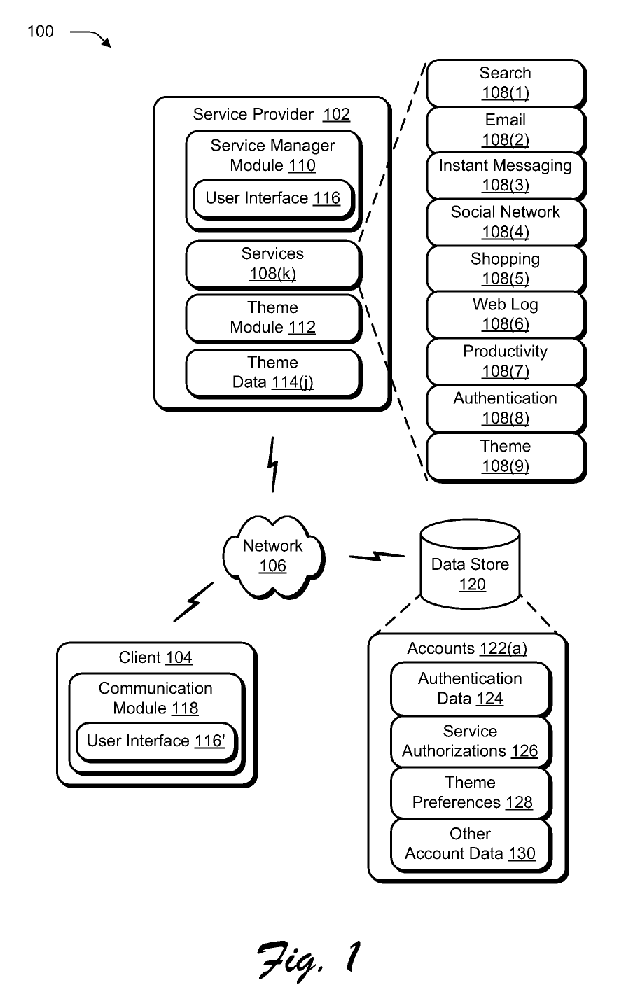

FIG. 1 is an illustration of an environment 100 in an example implementation that is operable to customize content aspects of a user interface in accordance with a selected theme. The illustrated environment 100 includes one or more service providers 102 and one or more clients 104 that are communicatively coupled, one to another, over a network 106. For purposes of the following discussion, a referenced component, such as client 104, may refer to one or more entities, and therefore by convention reference may be made to a single entity (e.g., the client 104) or multiple entities (e.g., the clients 104, the plurality of clients 104, and so on) using the same reference number.

The clients 104 may be configured in a variety of ways for accessing one or more service providers 102. For example, one or more of the clients 104 may be configured as a computer, such as a desktop computer, a mobile station, a laptop, an entertainment appliance, a set-top box communicatively coupled to a display device, a wireless phone, a game console, and so forth. Thus, the clients 104 may range from full resource devices with substantial memory and processor resources (e.g., personal computers, game consoles) to low-resource devices with limited memory, processing and/or display resources (e.g., traditional set-top boxes, hand-held game consoles, wireless phones). For purposes of the following discussion, the clients 104 may also relate to a person and/or entity that operate the clients. In other words, one or more of the clients 104 may describe logical clients that include users, software, and/or devices.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

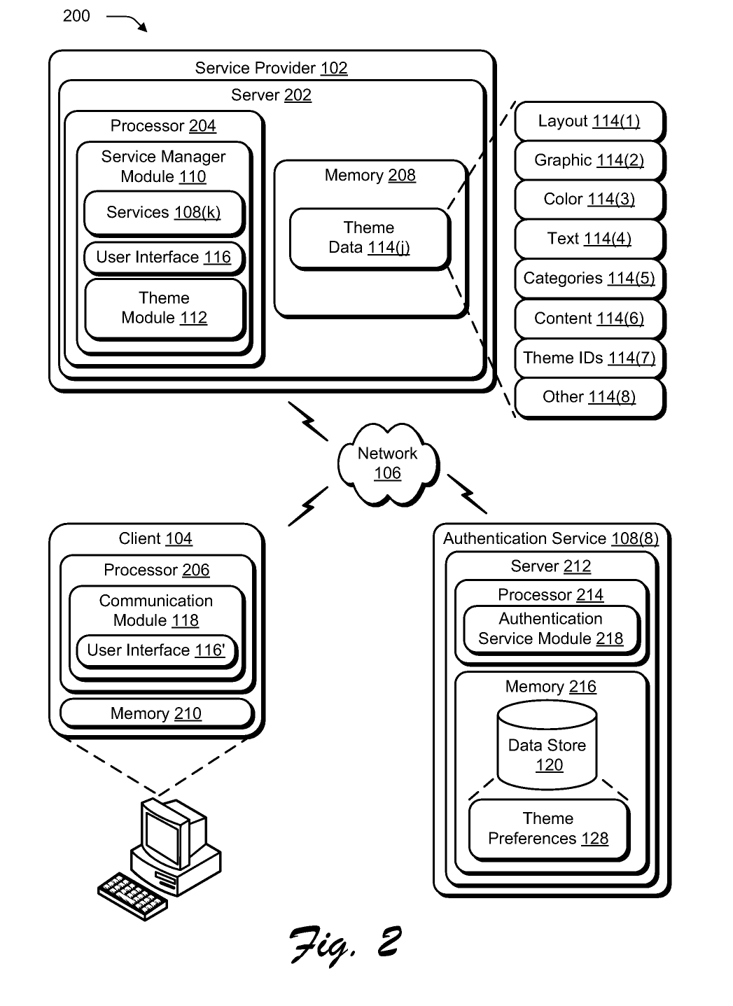

The service providers 102 are each illustrated as providing one or more services 108(k) (where “k” can be any integer from one to “K”). The services 108(k) may be configured in a variety of ways to provide a variety of functionality to the clients 104 over the network 106. For example, the services 108(k) may be configured for access via platform-independent protocols and standards to exchange data over the network 106. The services 108(k), for instance, may be provided via an Internet-hosted module that is accessed via standardized network protocols, such as a simple object access protocol (SOAP) over hypertext transfer protocol (HTTP), extensible markup language (XML), and so on, further discussion of which may be found in relation to FIG. 2.

A variety of functionality may be made available via the plurality of services 108(k). For example, as depicted in FIG. 1 services 108(k) may include but are not limited to: a search 108(1) service (e.g., an Internet search engine to search the Internet); an email 108(2) service to send and receive email; instant messaging 108(3) service to provide instant messaging between the clients 104; and an a social network 108(4) service to facilitate connections and interactions between groups of users who share common interests and activities. Social network 108(4) service may assist user in connecting to a group, provide a variety of ways for users to interact (e.g., group email, website, blog, messaging), and provide recommendations to the groups based upon shared interests and activities.

Additional examples of services 108(k) include: a shopping 108(5) service (e.g., “ecommerce”); a web log 108(6) service; and productivity 108(7) service. Productivity 108(7) service may provide various productivity applications as a service, such as word processing, spreadsheets, presentations, drawings, note-taking, and so on. For instance, network access may be given to a client 104 to applications that were traditionally executed locally on the client 104 itself. Therefore, execution of the applications may be performed remotely at a service provider 102 and results of the execution may be communicated over the network 106 to the clients 104. An authentication service 108(8) may also be provided to authenticate clients 104 to access other services 108(k) provided by one or more of the service providers 102.

In accordance with theme based content interaction techniques described herein, the plurality of services 108(k) may also include a theme 108(9) service. Theme 108(9) service represents a service that may apply a theme across the plurality of services 108(k) to provide a consistent look and feel (visual aspects). Theme 108(9) service may change aspects of user interfaces output by a service provider 102 in accordance with a theme associated with a client 104. Theme 108(9) service may be further operable to change not only the visual aspects according to a selected theme, but also change content aspects and/or functionality of various user interfaces according to a selected theme. Although a few examples of services 108(k) have been described, it should be apparent that a wide variety of other services 108(k) are also contemplated, such as desktop search service, a gadget service, a chat service, a news service, an advertisement service, and so on.

The service providers 102 are also illustrated as having respective service manager modules 110. The service manager modules 110 are representative of functionality used by the service providers 102 to manage access to the services 108(k) over the network 106, performance of the services 108(k) (e.g., load balancing), and so on. Although illustrated separately, the functionality represented by the service manager modules 110 may be incorporated within the services 108(k) themselves.

Service providers 102 are also depicted as including a theme module 112. Theme module 112 is representative of functionality operable to provide theme based content interactions to clients 104. For instance, functionality provided by theme module 112 may include but is not limited to: defining a plurality of themes, enabling users to select various themes, associating users with themes based on user selections, detecting a theme associated with a user and/or client 104, applying a detected theme across the plurality of services 108(k) and/or locally at a client 104 (e.g. to an OS desktop), updating theme selections, publishing a user defined theme for selection by a plurality of users, and so forth. Theme module 112 may utilize and manage a variety of theme data 114(j) in order to provide the theme 108(9) service to a plurality of clients 104 and users thereof. Theme data 114(j) may be configured in a variety of ways further discussion of which may be found in relation to FIG. 2.

While illustrated separately, theme module 112 may be implemented as a component of the service manager module 110. Further, while depicted as a component of service providers 102, in one or more implementations theme module 112 or equivalent functionality may be deployed at a client 104, may be distributed between one or more service providers 102 and clients 104, and so forth.

Further, the service manager module 110 may form and/or output a user interface 116 (or data sufficient to form the user interface 116) to enable the client 104 to interact with the services 108(k). Such interactions may include interactions with the theme 108(9) service to select a theme, update a theme, create a user defined theme, and so forth. In accordance with theme based content interaction techniques described herein, a user interface 116 formed and/or output by service provider 102 may be arranged to include customized visual aspects and content aspects in accordance with a theme detected through operation of the theme module 112. Moreover, service manager module 110 may output a variety of different user interfaces 116 corresponding to the various services 108(k) with which a client 104 may interact.

In an implementation, theme module 112 is operable to apply a detected theme across a wide variety of services 108(k). Thus, each of a variety of different user interfaces 116 corresponding to the variety of services 108(k) may be arranged to include customized visual aspects and content aspects in accordance with a detected theme. For instance, a user selected theme may be applied to change content portions presented in each of a home page, an email user interface, an instant messaging user interface, a desktop gadget, a search page, an operating system user interface, and so forth. A variety of other examples are also contemplated.

Clients 104 are depicted as including respective communication modules 118 through which various interactions with service providers 102 and services 108(k) may occur. Examples of such interactions include but are not limited to: navigating content; searching and selecting web pages; accessing services 108(k), performing searches; theme related interactions (e.g., execution of theme module 112 to obtain theme 108(9) service); instant messaging; email; and so on. The service manager module 110 may communicate the user interface 116 and/or data used to form the user interface 116 to the clients 104 via the network 106. The communication module 118 is further representative of functionality to obtain the user interface 116 or data communicated via the service manager module 110. Communication module 118 may then render a corresponding user interface 116′ at the client 104. The user interface 116′ rendered at the client 104 may include customized visual aspects and content aspects in accordance with a theme that is detected by the theme module 112.

Additionally, the environment 100 is illustrated as including a data store 120 which may represent functionality to maintain one or more accounts 122(a) (where “a” can be any integer from one to “A”). Each of the accounts 122(a) may correspond to a client 104, such as by corresponding to the device itself and/or a user that interacts with the device. Thus, each of the accounts 122(a) may include data that is utilized for interaction by a respective one of the clients 104 with the service providers 102 and/or the plurality of services 108(k). For example, the accounts 122(a) may correspond to a particular client 104 and include authentication data 124 (e.g., username, password, and/or other suitable credentials) used to authenticate the client's 104 identity (e.g., prove that a client 104 or user “is who they say they are”). Accounts 122(a) may also include respective service authorizations 126 which describe service providers 102 and/or services 108(k) that a user or client 104 may access when authenticated to a corresponding account 122(a).

In addition, theme preferences 128 may be included that describe a selected user theme, e.g., a theme associated with an account 122(a) or the user. For instance, a user may select a theme through operation of the theme module 112. The theme preferences 128 may then be stored to enable service providers 102 (e.g., through theme module 112) to detect a theme that the user has selected and apply the detected theme to corresponding services 108(k) with which the user interacts. A wide variety of other account data 130 is also contemplated, such as: user profile data; contacts; demographic data; personalized emoticons; user tiles; audio files; and so on.

Each of the accounts 122(a) may correspond to a particular one of the service providers 102 and/or services 108(k). Thus, authentication to one of the accounts 122(a) may provide access to a single corresponding service provider 102 and/or service 108(k). Additionally or alternatively, one or more of the accounts 122(a) may correspond to many services 108(k), such that authentication to a single one of the accounts 122(a) may provide access to many service providers 102 and/or to an entire suite of services 108(k) provided by a single service provider 102. Thus, rather than authenticate the client 104 to each of the service providers 102 or services 108(k) separately, the client 104 may perform a “single sign-on” (e.g., perform a single verification of credentials) to access a plurality of services 108(k) from one or more of the service providers 102.

The accounts 122(a) maintained via the data store 120 may be accessible to the clients 104 and/or service providers 102 via the network 106. For instance, the data store 120 may be accessible via the network 106 to reference the accounts 122(a) including the theme preferences 128. Thus, when interaction with services 108(k) are initiated by a client 104 (e.g., a user) using an account 122(a), theme module 112 may operate to obtain stored theme preferences 128 corresponding to the authenticated account 122(a). Thus, a user interface 116 which is output to enable interaction of the client 104 with one or more services 108(k) may be arranged in accordance with a theme specified by the stored theme preferences 128. Although illustrated separately, the data store 120 may be incorporated with the service providers 102 or with the clients 104. In an implementation, the data store 120 is provided via a standalone authentication service that is further described in reference to FIG. 2.

While the theme preferences 128 are depicted in FIG. 1 as being included with the accounts 122(a), it is contemplated that the theme preferences 128, and/or other data depicted as associated with the accounts 122(a), may be provided in a variety of ways throughout the environment 100. In an embodiment, theme preferences 128 may be maintained in a user preferences store or database which is separate from the accounts 122(a). For example, a user preference store having the theme preferences 128 may be located at the service provider 102 and/or at one or more of the clients 104, while the accounts 122(a) are located at a stand-alone authentication service 108(8) configured to perform authentication functions. Thus, the data store 120 may be representative of a plurality of data stores accessible via the network 106 which are not necessarily co-located.

Additionally, theme preferences 128 may be accessible without an associated client 104 being authenticated to an account 122(a). For instance, a cookie or other suitable data describing theme preferences 128 corresponding to a client 104 may be deployed to the client 104 and/or otherwise be associated with the client 104. Then, when the client 104 interacts with the service provider 102, the cookie or other data may be referenced to retrieve associated theme preferences 128 without the client 104 having to provide credentials for authentication. Thus, theme preferences 128 may be associated with a client 104 in addition to or in lieu of being associated with accounts 122(a). In this manner, clients 104 may experience theme based content interactions even without authentication to an associated account 122(a).

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of theme based content interaction techniques described below are platform-independent, meaning that the techniques may be implemented on a variety of commercial computing platforms having a variety of processors.

FIG. 2 is an illustration of a system 200 in an example implementation showing a service provider 102 and client 104 of FIG. 1 in greater detail. In FIG. 2, a service provider 102 is illustrated as being implemented by one or more servers 202 and the client 104 is illustrated as a client device.

The server 202 and the client 104 each include a respective processor 204, 206 and a respective memory 208, 210. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 208, 210 is shown, respectively, for the servers 202 and the client 104, a wide variety of types and combinations of memory may be employed, such as random access memory (RAM), hard disk memory, removable medium memory, and so forth.

As previously described, the services 108(k) of FIG. 1 may be configured in a variety of ways to provide functionality over the network 106 to the client 104. For example, the services 108(k) may be provided via one or more modules which are executed on the processor 204 and are storable in memory 208. For example, the service provider 102 is illustrated in FIG. 2 as executing the service manager module 110 on the processor 204. Service manager module 110 is illustrated as providing the plurality of services 108(k). In the example of FIG. 2, theme module 112 is illustrated a component of the service manager module 112, executed on the processor 204 and storable in the memory 208.

The service manager module 110, theme module 112, and the services 108(k) may be configured as Internet-hosted modules that are accessible via standardized network protocols. For example, the search 108(1) service may be configured as an Internet search module (e.g., a search engine) that examines an indexed search database to provide Internet searches. Search results may be stored in memory 208 and may represent an indexed search database that may cache results of common searches for quick access. Search results may also be generated at the time a search is performed. A variety of other examples of Internet hosting of the plurality of services 108(k) are also contemplated.

Additionally, a service 108(k) may also be provided as a stand-alone service. For example, an authentication service 108(8) may be provided by a server 212 configured for network 106 access and that has a processor 214 and memory 216, as depicted in FIG. 2. The authentication service 108(8) includes an authentication service module 218 that is executable on the processor 214 to authenticate the client 104 using authentication data 124 described with respect to FIG. 1. For instance, the client 104 may provide a username and password that is authenticated by the authentication service module 218 using the authentication data 124 of FIG. 1. When the authentication is successful (i.e., the client 104 “is who they say they are”), the authentication service module 218 may pass a token to the client 104 that is used by the client 104 to access corresponding services 108(k) of the service provider 102. As noted in the discussion of FIG. 1, a “single sign-on” may permit the client 104 to access many service providers 102 and/or an entire suite of services 108(k) provided by a single service provider 102.

In this implementation, the authentication service 108(8) may maintain the accounts 122(a) and corresponding data of FIG. 1, including the theme preferences 128 which may correspond to the client 104. For example, FIG. 2 depicts the data store 120 of FIG. 1 and theme preferences 128 as being maintained by the authentication service 108(8) in memory 216 of the server 212. Thus, the accounts 122(a) and theme preferences 128 may be referenced from the authentication service 108(8) by the service provider 102 and/or client 104 via the network 106.

As previously described, the service manager module 110 is representative of functionality that manages interaction of the client 104 with the plurality of services 108(k) of FIG. 1. The services 108(k) may be implemented as modules executable via the server 202 and processor 204 of FIG. 2. For instance, the service manager module 110 may provide data sufficient to form the user interface 116. Through operation of the theme module 112, the user interface 116 may be configured to include both visual aspects and content aspects that correspond to a detected theme. Data sufficient to form the user interface 116 may be communicated over the network 106 to the client 104. The data is used by the communication module 118 (which is illustrated as being executed on the processor 206 and is storable in memory 210 of the client 104) to output the user interface 116′ having the visual aspects and content aspects that correspond to the detected theme.

A variety of theme data 114(j) (which is illustrated as being stored in memory 208) is contemplated that may be employed to enable selection and application of themes to customize the content, arrangement, functionality and/or appearance of user interfaces 116 output for interaction with a plurality of services 108(k). For example, theme data 114(j) may include selectable options to specify visual aspects for a theme including but not limited to: layout 114(1) options that may specify arrangement of various content portions one to another in a user interface 116; graphics 114(2) options such as a custom images for the background, icons, controls, links, and/or user tile; color 114(3) options for text, lines, background borders, and tables; and text 114(4) options such as fonts, size, hyperlinked or normal, style (italics, bold, underline, numbered) and so forth.

Theme data 114(j) may further include category 114(5) data by which various defined themes may be organized. Thus, a client 104 may navigate themes categorically to search and/or select available themes. Further, a theme defined by service provider 102, a user 104, or a third party may be associated with one or more categories to facilitate searching and selecting of the theme.

Theme data 114(j) may further include content 114(6) data to relate a theme to various content aspects. Thus, in addition to being associated with the above noted visual aspects, a theme may also correspond to content aspects that may be applied to portions of a user interface 116. Content 114(6) data may describe links to websites, images, feeds, advertisements, and so forth. Portions of a UI 116 may be varied according to the content 114(6) data to include different information based upon an associated theme. Further, various portions may be added or deleted from a UI 116 according to a theme. Thus, content 114(6) data may associate different content aspects for portions of a UI 116 with different themes. Further discussion of modifying portions of a UI 116 to include content in accordance with a detected theme may be found in relation to the following figures.

Theme data 114(j) may also include theme identifiers 114(7) (e.g., theme IDs) which may be uniquely associated with a theme to identify the theme. Theme IDs 114(7) may be used to create associations between a theme and services 108(k), users, accounts 122(a), clients 104, and so forth. A variety of other 114(8) theme data is also contemplated, such as: theme names; ratings for themes; a theme author; access permissions; descriptions; and so forth. Thus, theme data 114(j) may be used to create a plurality of themes, each of which is a collection of settings for visual aspects and content aspects that may be centered around a particular topic, e.g., the theme. Further aspects of theme based content interaction techniques may be found in the discussion of the following example procedures and user interfaces

Example Procedures

The following discussion describes theme based content interaction techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the system 200 of FIG. 2.

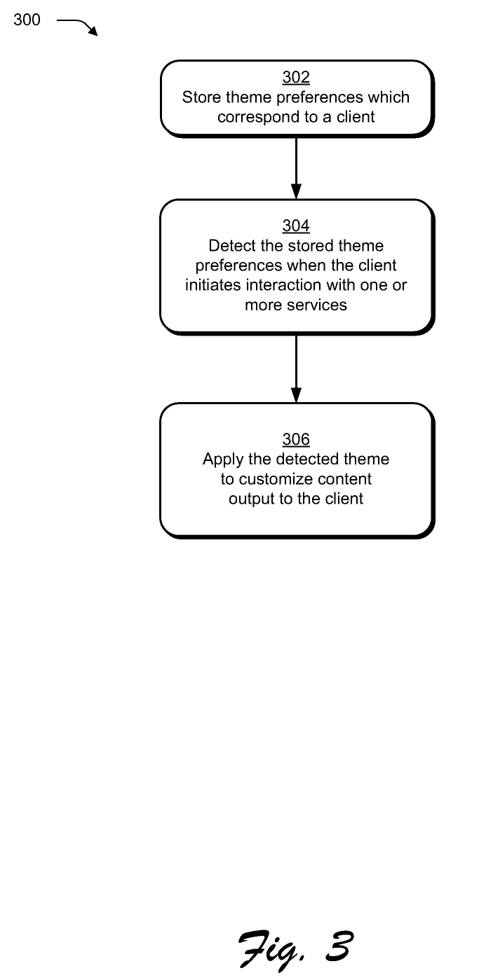

FIG. 3 depicts a procedure 300 in an example implementation in which content output by a service provider is customized in accordance with detected theme preferences. Theme preferences are stored that correspond to a client (block 302). For example, the client 104 of FIG. 2 may execute a communication module 118 configured as a browser and navigate over the network 106 to a network address of the service provider 102. The client 104 may also provide authentication information, such as username and password, to authenticate the identity of the client 104. Authentication service 108(8) may operate to authenticate the identity of the client 104. In particular, the client 104 may be authenticated to an account 122(a) corresponding to a user. The client 104 may access one or more services 108(k) based on the authentication to the account 122(a), including the theme service 108(9).

More particularly, theme module 112 may be executed to provide a variety of theme options to the client 104. Through various interactions with the theme module 112, the user of the client 104 may define a theme, select a theme, and/or associate the client 104 and/or user with a selected theme. For the purposes of this example, assume that the user selects a theme that is associated with “Sports”. As noted previously, the theme may specify both corresponding visual aspects and content aspects of a user interface 116. In the present example, both the visual aspects and content aspects of the theme may be centered around “Sports”. The association of the client 104 and/or user with a theme may be accomplished through theme preferences 128 that may be stored in data store 120. Thus, theme preferences 128 may be stored that associate themes with accounts 122(a).

Stored theme preferences are detected when the client initiates interaction with one or more services (block 304). In the previous example, the client 104 may interact with a search 108(1) service provided by the service provider 102 to navigate web pages and perform searches. When the client 104 initiates interaction with the search service 108(1), theme module 112 may operate to identify a theme associated with the client 104. In particular, the theme preferences 128 associated with an authenticated account 122(a) may be referenced by the theme module 112 from the data store 120. The stored theme preferences 128 may indicate a theme ID 114(7) of the “Sports” theme that was previously selected. Accordingly, the theme module 112 may use theme preferences 128 to detect a theme associated with the user and/or a client 104.

The detected theme is applied to customize content output to the client (block 306). Continuing the preceding example, the detected theme ID 114(7) may be used by theme module 112 to obtain and/or identify customized aspects of the selected “Sports” theme. In particular, theme module 112 may utilize theme data 114(j) to apply the “Sports” theme. A variety of content 114(6) data may be associated with the detected “Sports” theme. For instance, sports related feeds, links, advertisements, offers, images, and so forth may be included in the user interface 116 output to provide the search 108(1) service.

Certain content portions may be added or deleted based upon a detected theme. For instance when the “Sports” theme is selected, a sports score ticker may be included in the user interface 116 to provide search 108(1) service. However, when a different theme such as a “Garden” theme is selected, the sports ticker may be omitted from the user interface 116 that is output to provide the search 108(1) service.

In an implementation, a script used to generate a user interface 116 may include variable references to the theme data 114(j). The variable references may be interpreted by the theme module 112 and/or communication module 118 based upon a theme ID 114(7) of a detected theme. Theme module 112 and/or communication module 118 may use the variable references in conjunction with the theme ID 114(7) to render a user interface 116 that includes visual aspects and content aspects customized in accordance with a corresponding theme.

For instance, a plurality of variable content portions of a user interface may be referenced in the script by variable references to content portions. The variable references may be implemented as tags that correspond to variable content portions such as theme_image, theme_header, theme_ad, theme_feeds, theme_links, and so forth. The variable references along with the theme ID 114(7) provide a mechanism by which theme module 112 may vary the content portions in accordance with a detected theme.

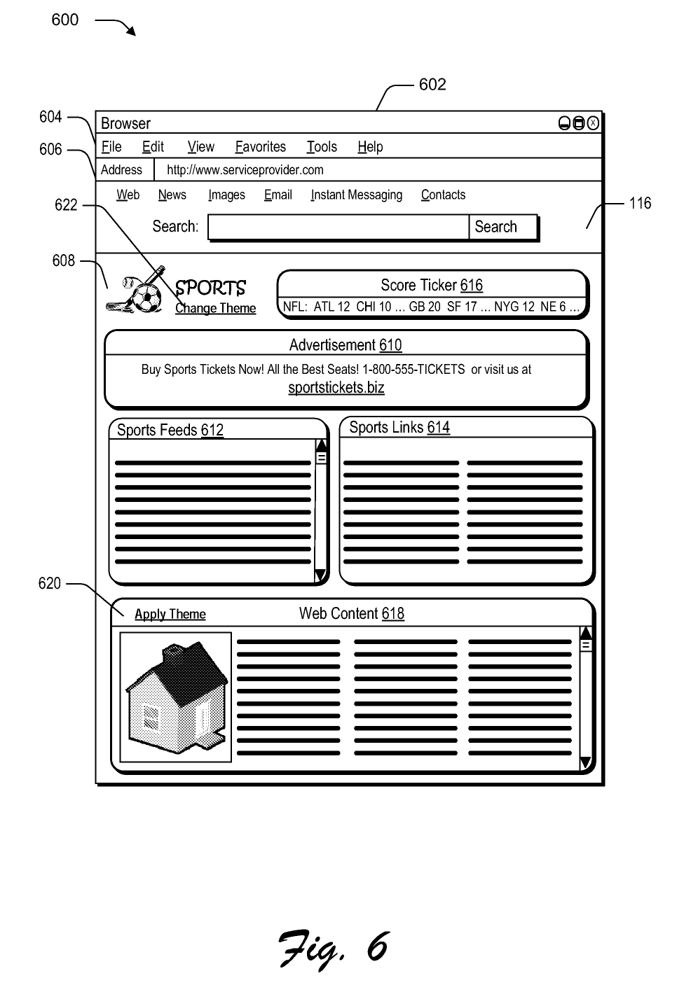

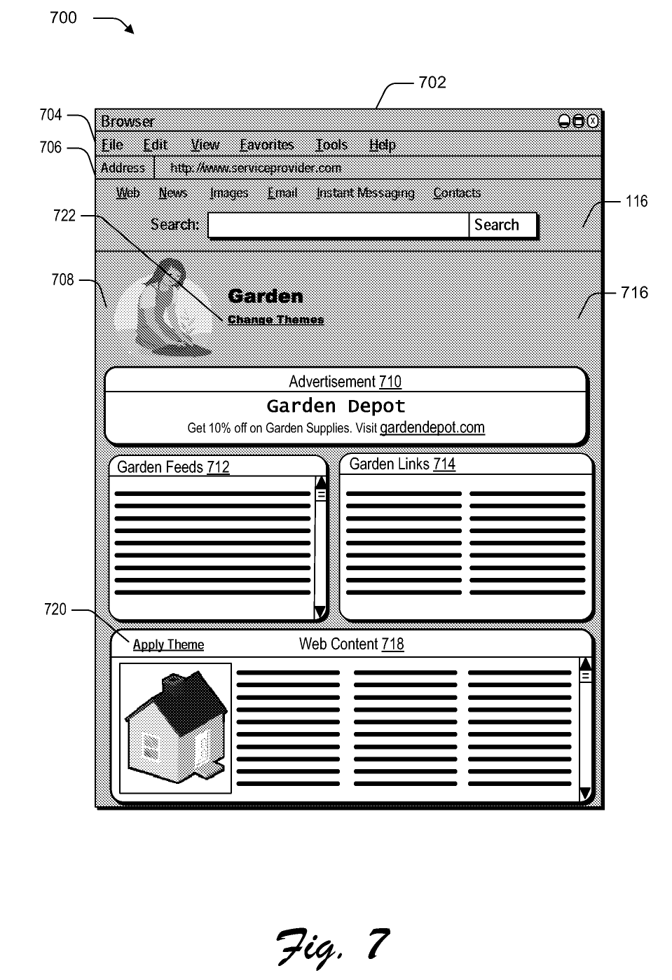

Thus, when the “Sports” theme is detected, theme module 112 may use the corresponding theme ID 114(7) to query the theme data 114(j) and identify/obtain images and/or text to render for the theme_header portion. Further, a targeted advertisement related to sports may be identified through the theme data 114(j) and rendered for the theme_ad portion. Thus, theme module 112 may lookup particular content to include in a user interface in accordance with a detected theme. FIGS. 6 and 7, discussed in greater detail below, illustrate examples of user interfaces 116 having content portions customized in accordance with “Sports” and “Garden” themes respectively. The script may also include data indicating whether themes are enabled or disabled for the particular user interface 116. When themes are disabled, a user interface 116 may be rendered using default settings for visual aspects and content aspects.

In another implementation, services 108(k) provided by a service provider 102 to a user may also be chosen and/or customized on the basis of a selected theme. In conjunction with providing services 108(k) on a theme basis, content portions that enable and/or provide links to theme based services 108(k) may be added or deleted from a user interface 116 as described previously.

One example of providing services on a theme basis involves using detected theme preferences 128 to understand social network affinity. Then, social network 108(4) service may be provided in accordance with a selected theme as determined through theme preferences 128. For instance, theme module 112 may include functionality to relate users to social networks available through social network 108(4) service in accordance with selected themes of the users. Theme module 112 may further cause social network recommendations to be communicated to users. Social network recommendations may be communicated via a user interface 116 that has been customized in accordance with a selected theme. Additionally or alternatively, the social network recommendations may be communicated by a variety of other techniques example of which include: email, text messages, instant messages, a phone call, voicemail, and so forth. It is contemplated, that a social network recommendation may include one or more selectable links to enable a user to accept or decline joining the social network directly (e.g., without navigating away from the social network recommendation).

For instance, when selection of the “Sports” theme by a user is detected, this may cause a social network recommendation to join a “Green Bay Packers Fans” social network to be communicated to the user by theme module 112. In an implementation, theme module 112 may interact with social network 108(4) service to cause the social network 108(4) service to generate and communicate the recommendation. If the user decides to join, a home page of the user may be updated to include one or more content portions that enable and/or link to the “Green Bay Packers Fans” social network. Thereafter, if the user changes to their theme to a “Garden” theme, this may cause a social network recommendation to join a “Weekend Gardener's Club” social network. The user's home page may be updated accordingly. Thus, theme selection may be employed to assist users in making connections through social networks that are related to selected themes.

In another example of providing theme based services 108(k), assume a user selects a theme related to the city of “Seattle”. Selection of the “Seattle” theme may enable a public chat room that is organized around users who have also selected the “Seattle” theme. For instance, a link to the public chat room may appear in a user interface 116 (e.g., user home page), when the user selects the “Seattle” theme. Additionally or alternatively, an invitation and/or link to join the chat room may be communicated though email, text messages, instant messages, phone call, voicemail, and so forth. Thus, chat service from a service provider 102 may also be provided on a theme basis. A variety of other examples of providing services 108(k) on a theme basis are also contemplated.

Accordingly, theme selections may be leveraged by a service provider 102 in a variety of ways to serve theme related content and services. The content and services may be reflected by portions of a user interface 116 that are modified, added, updated, and/or removed to correspond to a user selected theme.

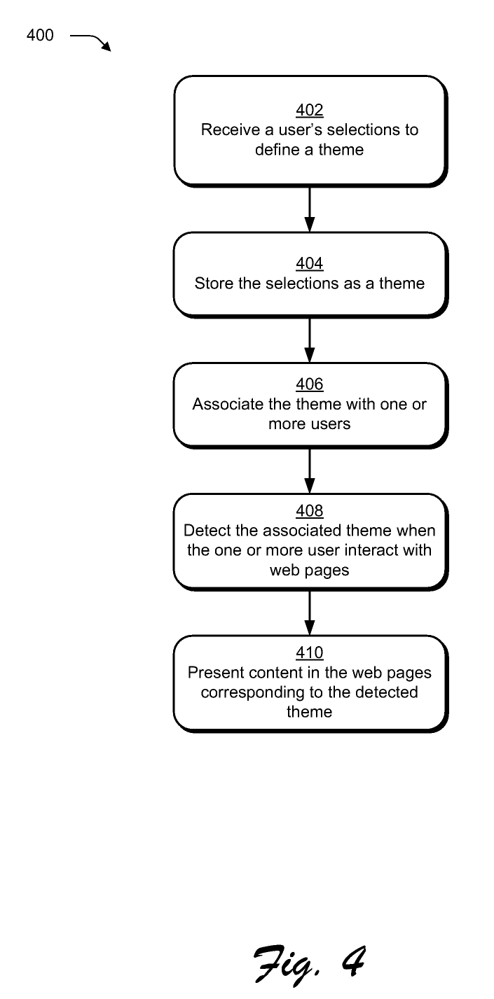

FIG. 4 depicts a procedure 400 in an example implementation in which content corresponding to a user defined theme is presented in a web page. A user's selections are received to define a theme (block 402). For example, a user may interact with the service provider 102 and initiate a theme module 112 to define a custom theme. In this example, assume the user is an avid gamer who wishes to create a theme centered around the XBOX game console (XBOX is a registered trademark of Microsoft Corporation, Redmond, Wash.). Theme module 112 may include functionality to expose a variety of selectable options to enable a user to define a theme. For instance, a user may specify visual aspects for a custom “XBOX” theme such as fonts, background image, colors, texts, and so forth. In this example, the user may choose visual aspects to mimic the look and feel of XBOX. Theme module 112 may enable the user to upload certain theme aspects such as custom images, fonts, colors, and so forth. The user may also specify content aspects for variable content portions such as XBOX related website links, a game related podcast, game related advertisements, and so forth.

Theme module 112 may also enable the user to develop certain theme specific content portions. For instance, user might create a custom gamer profile portion that provides a link to online XBOX gamer profiles. The gamer profile portion may be added to a user interface 116 when the “XBOX” theme is detected and removed when a different theme is detected. Thus, a theme may modify existing content portions with theme specific content and/or enable theme specific functionality to be introduced to user interfaces 116 through theme specific content portions. Naturally, the service provider 102 may develop and/or maintain a number of predefined themes that a user may select, in addition to or in lieu of users creating custom themes.

The selections are stored as a theme (block 404). For instance, the XBOX theme defined in the preceding example may be stored as theme data 114(j) that is related to a unique theme ID 114(7). The user may specify whether the XBOX theme is public or private. Thus, a user may decide to publish and share a customized theme with other people. A theme may be shared with the general public, a particular group (e.g., a social network), a few close friends, and so forth.

The theme is associated with one or more users (block 406). For instance, when the XBOX theme in the preceding example is created and/or published, various users may then select the theme. When users select the XBOX theme, theme preferences 128 may be stored to associate the XBOX theme with the users. In an implementation, the theme ID 114(7) of the XBOX theme is associated with accounts 122(a) of users who select the theme.

The associated theme is detected when the one or more users interact with web pages (block 406) and content is presented in the web pages corresponding to the detected theme (block 408). For example, a user that has selected the XBOX theme of the foregoing example may navigate to a home page of service provider 102. The home page may be configured to enable themes. In an implementation interacting of the user with the home page may cause execution of theme module 112. Theme module may operate to identify a theme associated with an account 122(a) used by the user to interact with the home page.

In this example, theme module 112 may reference theme preferences 128 corresponding to an account 122(a) to understand that the account 122(a) is associated with the XBOX theme. In particular, theme module 112 may obtain a theme ID 114(7) that has been associated with the account 122(a). Then, visual aspects and content aspects specified by theme data 114(j) related to the XBOX theme may be identified by the theme module 112. Then, theme module 112 may cause forming and/or output of the home page in accordance with the selected XBOX theme. Based upon the detected XBOX theme, the home page may include visual aspects to mimic the look and feel of XBOX and XBOX customized content aspects, such as XBOX related website links, a game related podcast, game related advertisements, the custom gamer profile portion, and so forth.

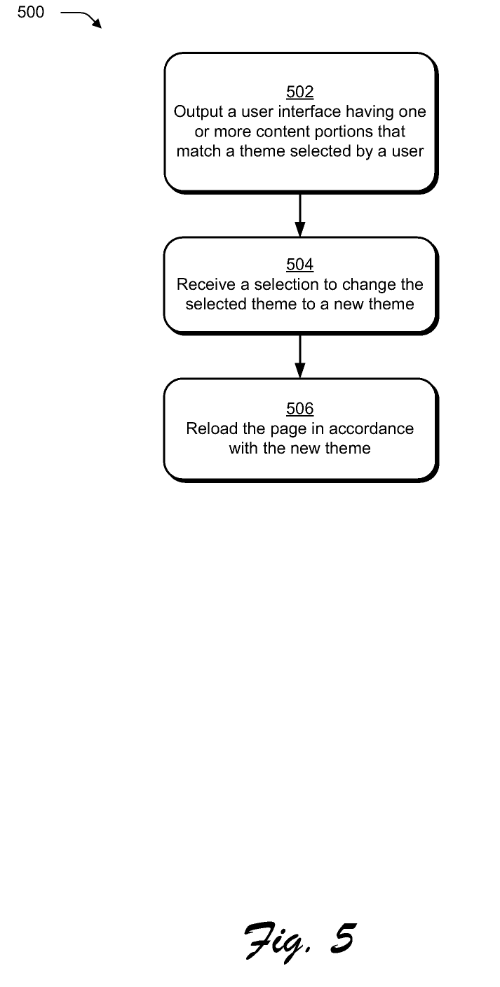

FIG. 5 depicts a procedure 500 in an example implementation in which a user interface is updated to reflect selection of a new theme by a user. During the discussion of the procedure 500 of FIG. 5, reference will also be made to the example user interfaces shown in FIGS. 6-7. A user interface is output having one or more content portions that match a theme selected by a user (block 502). For example, assume that a client 104 is authenticated to an account 122(a). Account 122(a) may be associated with a “Sports” theme through theme preferences 128 as previously described. Theme module 112 may operate to detect the theme and apply the theme to a user interface 116 output for interactions with services 108(k).

Referring now to FIG. 6, an example implementation 600 is illustrated showing an example user interface 116 that includes one or more content portions to match a theme selected by a user. In the example of FIG. 6, the user interface is arranged to match a “Sports” theme. The user interface 116 in this instance is illustrated as incorporated within a user interface 602 provided by the communication module 118 of the client 104. For example, the communication module 118 may be configured as a browser that includes a menu bar 604 and an address bar 606. The menu bar 604 is a portion of the user interface 602 that includes drop-down menus of commands, examples of which are illustrated as “file”, “edit”, “favorites”, “tools” and “help”. The address bar 606 is configured to receive inputs to navigate to particular network addresses and/or display current network addresses, from which, the client 104 has received content that is being displayed.

The user interface 602 also includes the user interface 116 formed from data obtained via the network 106 from the service provider 102. The user interface 116 formed from the service provider 102 data may include one or more content portions that are variable and may be configured to match a detected theme. In particular, a theme header 608 portion, advertisement 610 portion, theme feed 612 portion, and theme links 614 portion that each correspond the “Sports” theme are illustrated. Thus, the theme header 608 portion presents a sports image and the title “Sports”. The advertisement in the advertisement 610 portion relates to a web merchant that sells tickets to sporting events. Likewise, theme feed 612 portion, and theme links 614 portion may include content customized to match the “Sports” theme.

The user interface 116 also includes a score ticker 616 that provides functionality specific to the selected “Sports” theme. Score ticker 616 may be added when “Sports” is a selected theme and removed when another theme is selected. Other portions of user interface 116, such as the menu bar 604 and the address bar 606 may be independent of themes. Thus, these portions may appear the same for different selected themes.

In the depicted example, user interface 116 also includes a web content portion 618. Web content 618 portion is representative of content portions for which theme dependence may be optional. For instance, when a UI 116 is initially rendered, content in the web content 618 portion may be independent of the theme. For instance, the content may provide a web portal having variety of links to web content for many topics, e.g., news, sports, travel, games, maps, music, shopping, and so forth.

The web content portion 618 includes an apply theme 620 control that may be selected to update the web content 618 portion to match the theme. Thus, by operating the apply theme 620 control, the web content 618 portion may be updated to match the selected “Sports” theme. In this example, web content 618 portion may be updated to include sports news, links to sports related websites, sports scores, and so on. The apply theme 620 control may then be operable to undo application of the theme to the web content 618 portion. Thus, some content portions of a user interface 116 may be configured to enable optional selection and de-selection of theme based content.

Referring back to FIG. 5, a selection is received to change the selected theme to a new theme (block 504). For, the purposes of example assume that a user interacts with service provider 102 to select a new theme. In the depicted example of FIG. 6, a selectable change theme 622 control is illustrated. Change theme 622 control represents functionality operable by a user to select a new theme. Manipulation of the change theme 622 control may cause execution of the theme module 112 to expose a theme selection user interface. In this example, the user may navigate the theme selection user interface to choose a new theme, such as a “Garden” theme. Theme preferences 128 corresponding to the user may be updated to reflect the selection of the “Garden” theme. For instance, a theme ID 114(7) corresponding with the “Garden” theme may be associated with an account 122(a) of the user.

The user interface is reloaded in accordance with the new theme (block 506). For instance, the user interface 116 of FIG. 6 to which a “Sports” theme is applied, may be updated to reflect the change from the “Sports” theme to the “Garden” theme. Referring now to FIG. 7, an example implementation 700 is depicted showing the user interface of FIG. 6 following selection of a different theme by user. In particular, FIG. 7 illustrates a user interface 116 to which a “Garden” theme has been applied.

The user interface 116 in FIG. 7 is illustrated as incorporated within a user interface 702 provided by the communication module 118 of the client 104. For example, the communication module 118 may be configured as a browser that includes a menu bar 704 and an address bar 706 comparable to the browser discussed with respect to FIG. 6.

A variety of content portions in FIG. 7 are updated relative to corresponding portions of FIG. 6 to reflect the change to the “Garden” theme from the “Sports” theme. In particular, a theme header 708 portion, advertisement 710 portion, theme feed 712 portion, and theme links 714 portion are illustrated as corresponding to the new “Garden” theme. Accordingly, the theme header 708 portion presents a garden image and the title “Garden”. The advertisement in the advertisement 710 portion relates to a web merchant that sells garden supplies. Likewise, theme feed 712 portion, and theme links 714 portion may include content customized in accordance with the “Garden” theme. Further, the background is illustrated as having a different color which matches the “Garden” theme. Additional visual aspects may also be changed when a new theme is applied, such as changes to: fonts; layout of content portions; and so forth.

It is noted that in a portion 716 of FIG. 7, the sports ticker 616 portion of FIG. 6 has been removed. In other words, user interface 116 may be configured to provide different functionality depending upon which theme (“Sports” or “Garden”) is selected. In this case, the sports ticker 616 is included for the “Sports” theme but is removed for the “Garden” theme.

Web content 718 portion in the example of FIG. 7 may initially provide the same content as corresponding web content 618 portion of FIG. 6. Again, an apply theme 720 control is illustrated that may be operable to apply the “Garden” theme of FIG. 7 to content presented in web content 718 portion. Likewise, a change theme 722 control is illustrated that may be used to select a different theme, including returning to the “Sports” theme of FIG. 6. Accordingly, a selection of a new theme may cause a corresponding change in visual aspects and content aspects of a user interface 116, as illustrated in FIGS. 6-7.

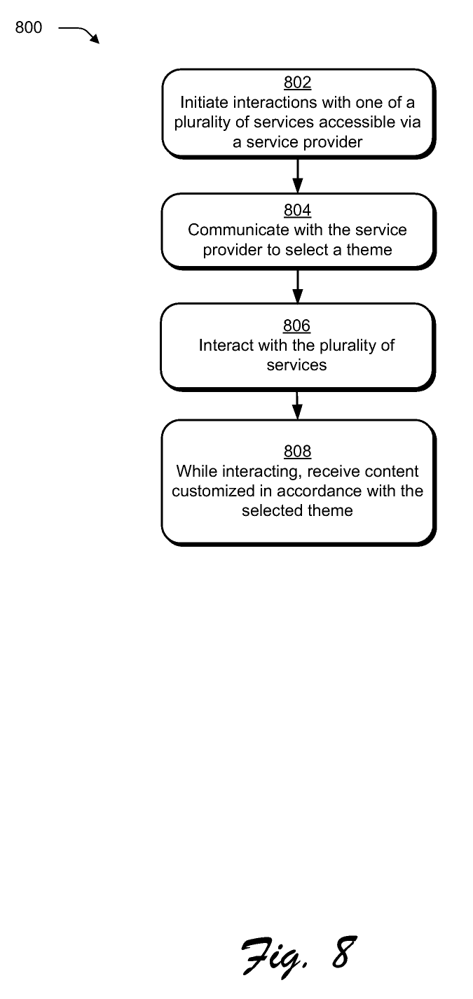

FIG. 8 depicts a procedure 800 in an example implementation in which a client receives content customized in accordance with a selected theme across a plurality of services provided by a service provider. A client initiates interaction with one of a plurality of services accessible via a service provider (block 802). For example, a client 104 may navigate a communication module 118 to a home page associated with a service provider 102. Client 104 may be prompted to authenticate to an account 122(a) with the service provider 102. While authenticated to the account 122(a), the client 104 may obtain access to a plurality of services 108(k).

The client communicates with the service provider to select a theme (block 804). Continuing the previous example, once the client 104 has been authenticated, the client 104 may communicate with service provider 102 to cause theme module 112 to expose a theme selection user interface. Through the theme module 112 and the theme selection user interface, client 104 may communicate selection of theme, which may be a predefined theme or a custom theme. Responsive to the selection, theme module 112 may update theme preferences 128 of the account 122(a) to associate the account 122(a) with a selected theme.

The client interacts with a plurality of services (block 806) and while interacting with the plurality of services, the client receives content that is customized in accordance with the selected theme (block 808). For instance, the client 104 may interact in a variety of ways with many services 108(k) provided by the service provider 102. Examples of these interactions may include: navigating web content through search 108(1) service; obtaining email through email service 108(2); interacting with instant messages through instant messaging 108(3) service; shopping through shopping 108(5) service; accessing a social network; and so forth. Service provider 102 may output a variety of user interfaces 116 to enable the variety of interactions. In accordance with theme based content interaction techniques discussed herein, multiple user interfaces 116 output for interaction with the plurality of services 108(k) may each be customized in accordance with a selected theme. Thus, when a “Sports” theme is selected sports related ads, links to sports content, and sports functionality (e.g., sports ticker 616) may appear across the plurality of services 108(k). Likewise, when an XBOX theme is selected, game related ads, links to game websites, and game functionality (e.g., gamer profile portion) may appear across the plurality of services 108(k). Thus, client 104 receives content customized in accordance with a selected theme across a plurality of services 108(k) that may be provided by a service provider 102.

While certain aspects of theme based content interaction techniques have been described in relation services 108(k) provided by service provider 102, it is contemplated that the techniques may be used to extend themes to content aspects in a wide variety of settings. For example, theme based content interaction techniques may be implemented to customize user interfaces 116 output in a desktop environment. In one example, a desktop theme selected to change the look and feel of an operating system user interface locally at a client 104 may be detected and applied to customize Internet content that is received through communication module 118. In another example, a desktop theme or a theme associated with an account 122(a) may be detected and applied to customize content portions of user interfaces locally on a client 104, such as customizing content displayed via an operating system user interface, a desktop gadget, an RSS feed, a user interface output by a desktop application of the client 104, a desktop sidebar, and/or other content portions output by the client 104. In an implementation, functionality equivalent to that of the described theme module 112 may be deployed on the client 104 to enable theme based content interaction in the desktop environment. A variety of other examples are also contemplated.

Conclusion

Although the theme based content interaction techniques have been described in language specific to structural features and/or methodological acts, it is to be understood that the appended claims are not necessarily limited to the specific features or acts described. Rather, the specific features and acts are disclosed as example forms of implementing the theme based content interaction techniques.

What is claimed is:

1. A method comprising:
detecting a theme associated with a client when the client initiates output of a user interface to provide interaction with content;
applying the detected theme to customize content aspects of the user interface; and
outputting the user interface having the customized content aspects to provide the interactions.

2. A method as described in claim 1, wherein applying the detected theme is further to customize visual aspects of the user interface output to provide the interactions.

3. A method as described in claim 1, wherein the content aspects that are customized by application of the detected theme are selected from a group consisting of:
an advertisement;
an Internet feed;
a desktop gadget;
a desktop sidebar;
a portion of a desktop user interface of the client;
an image;
a link to theme related content; and
an Internet address.

4. A method as described in claim 1 further comprising:
storing theme preferences to associate the theme with the client; and
referencing the stored theme preferences to detect the theme associated with the client.

5. A method as described in claim 1, wherein applying the theme to customize content aspects of the user interface includes exposing a customized content portion in the user interface that provides functionality related to the theme.

6. A method as described in claim 1, wherein the user interface is a desktop user interface output by an operating system of the client.

7. A method as described in claim 1 wherein the user interface is a user interface output to the client over a network by a service provider that provides a plurality of services to the client.

8. A method as described in claim 7, wherein the theme is applied by the service provider to customize content aspects of multiple user interfaces output by the service provider to provide interactions across the plurality of services.

9. A method as described in claim 8 further comprising applying the detected the theme to customize content aspects of a desktop user interface output by an operating system of the client.

10. A method as described in claim 1, wherein detecting a theme associated with the client comprises:
determining that the client is authenticated to an account with a service provider through which the client is provided access to a plurality of services; and
referencing a theme identifier associated with the authenticated account to identify the theme.

11. A method comprising:
communicating with a service provider to select a theme;
interacting with a plurality of services accessible via the service provider; and
while interacting with the plurality of services, receiving content customized in accordance with the selected theme.

12. A method as described in claim 11 further comprising sending credentials to authenticate to an account configured to enable the interacting with the plurality of services accessible via the service provider.

13. A method as described in claim 11, wherein the content customized in accordance with the selected theme includes an advertisement related to the selected theme.

14. A method as described in claim 11, wherein the content customized in accordance with the selected theme includes a portion of a web page having one or more links to web sites related to the selected theme.

15. A method as described in claim 11, wherein the content customized in accordance with the selected theme includes a portion of a web page having an Internet feed related to the selected theme.

16. One or more computer readable media comprising instructions that are executable to:
authenticate a client to interact with a plurality of services via a network;
determine theme preferences corresponding to the client which identify a theme associated with the client; and
apply the identified theme to customize visual aspects and content aspects of a plurality of user interfaces output to enable interaction across the plurality of services.

17. One or more computer readable media as described in claim 16 wherein the instructions are executable to determine theme preferences corresponding to the user by referencing stored theme preferences which are associated with an authenticated user account used by the user to initiate interaction with the plurality of services.

18. One or more computer readable media as described in claim 16, further comprising instructions that are executable to:
expose a user interface having one or more selectable portions to change a theme associated with the client;
receive input to associate a new theme with the client; and
customize the visual aspects and content aspects of the plurality of user interfaces in accordance with the new theme.

19. One or more computer readable media as described in claim 16, wherein the content aspects are selected from a group consisting of:
an advertisement;
an Internet feed;
a desktop gadget;
a desktop sidebar;
a portion of a desktop user interface of the client;
an image;
a link to theme related content; and
an Internet address.

20. One or more computer readable media as described in claim 16, further comprising applying the identified theme to customize visual aspects and content aspects of a desktop user interface output by an operating system of the client.
